(19) United States
(12) Patent Application Publication
(10) Pub. No.: US 2020/0357074 A1
(43) Pub. Date: Nov. 12, 2020

(54) SYSTEMS AND METHODS FOR PROVIDING GROUP INSURANCE

(71) Applicant: METROPOLITAN LIFE INSURANCE CO., New York, NY (US)

(72) Inventor: Terrance Luciani, Monroe Township, NJ (US)

(21) Appl. No.: 16/940,823

(22) Filed: Jul. 28, 2020

Related U.S. Application Data
(63) Continuation-in-part of application No. 14/092,255, filed on Nov. 27, 2013.
(60) Provisional application No. 61/730,309, filed on Nov. 27, 2012.

(51) Int. Cl. G06Q 40/08; G06Q 30/02; G06Q 50/00; G06F 9/54

(52) U.S. Cl. CPC G06Q 40/08; G06F 9/547; G06Q 50/01; G06Q 30/0277

(57) ABSTRACT

An insurance server accesses communications from at least one social media platform. The accessed communications include at least one of text data or image data. The insurance server determines a portion of the communications corresponds to a category of activity. For this category of activity, the insurance server determines a level of risk based on a potential for injury. Based on the level of risk for the category of activity, the insurance server identifies at least one insurance product. The insurance server further identifies a set of users associated with the portion of the communications and insures this set of users for the category of activity based on the at least one insurance product.

### CROSS-REFERENCE TO RELATED APPLICATIONS

This application is a continuation-in-part of U.S. Non-Provisional application Ser. No. 14/092,255, filed Nov. 27, 2013, and which claims the benefit of U.S. Provisional Application No. 61/730,309, filed Nov. 27, 2012, the contents of each are incorporated herein by reference to its entirety.

### TECHNICAL FIELD

Various embodiments of the present invention relate to insurance and, more particularly, to systems and methods for providing insurance to a group of individuals based on an interest shared amongst the individuals.

### BACKGROUND

Group insurance is conventionally provided at a discount rate to members of a group, based on membership in a common organization. Other group rate policies stem from employment as sponsored by the employer.

A key distinction between group insurance and individual insurance is that, for group insurance, risk is spread throughout the entire group. In many instances, this can result in lower insurance premiums for individuals within a group.

### SUMMARY OF THE INVENTION

The present invention is directed to a computer-implemented method and/or an insurance system wherein the system compiles and ingests data associated with a group of individuals with a shared interest and evaluates said data to determine a group insurance policy. In one aspect of the present invention, said data is obtained from a social networking server and/or online community.

Another aspect of the present invention is to provide a group insurance policy at a lower cost than an individual policy, where the shared interest is a high-risk activity.

Yet another aspect of the present invention is to compile accurate and specific data and characteristics associated with a group at a low cost.

### BRIEF DESCRIPTION OF THE FIGURES

FIG. 1 illustrates a computing environment in which an insurance system or method may be implemented, according to an exemplary embodiment;

FIG. 2 illustrates a computing environment in which an insurance server processes data from one or more social media platforms to identify a set of groups to which insurance products can be presented, according to one or more exemplary embodiments;

FIG. 3 illustrates a computing environment in which a risk analysis system of an insurance server processes incoming data from a data crawler to identify a set of groups and determines a risk score for each group to be used to identify insurance products for each group, according to one or more exemplary embodiments;

FIG. 4 illustrates a process for identifying a set of groups based on data obtained from one or more social media platforms and determining insurance products that can be presented to each group, according to one or more exemplary embodiments; and

FIG. 5 illustrates a computing system architecture including various components in electrical communication with each other using a connection, according to one or more exemplary embodiments.

### DETAILED DESCRIPTION

According to one or more embodiments of the disclosure, an insurance server accesses activities/communications from one or more social media platforms to obtain various content shared within the one or more social media platforms. This content can include text data (e.g., posts, comments, etc.) and image data (e.g., pictures, drawings, memes, etc.). From these communications, the insurance server determines a portion of the communications that corresponds to a category of activity. The insurance server determines, based on a potential for risk associated with the category of activity, a risk level for the category of activity. The solution can then match an at least one appropriate insurance product based on this level of risk. From this portion of activity/communications, the insurance server identifies users that collectively form an ad hoc or affinity group associated with the category of activity. Further, the insurance server provides a method for insuring this set of users for the category of activity based on the identified insurance product selected based on the level of risk.

To facilitate an understanding of the principles and features of embodiments of the present invention, those principles and features are explained with reference to their implementations in illustrative embodiments. The components described hereinafter as making up various elements of the invention are intended to be illustrative and not restrictive. Many suitable components that would perform the same or similar functions as the components described are intended to be embraced within the scope of the invention. Such other components can include, for example, components developed after development of the invention.

Exemplary embodiments of the invention are computer based systems and methods for providing group insurance in accordance with the unique attributes of a given group. In an exemplary embodiment, an insurance provider may identify potential insureds through a social networking of group-related activities accessed by a web portal, such as a website, and/or an Application Programming Interface (API).

In particular, social network sites such as Facebook, Instagram, Tik Tok, Twitter allow the formation and enhanced communication of a diverse group of individuals brought together by some common interest. The use of this type of communication platform permits an exchange of information that is unprecedented.

This information is not only seamlessly collected, reflecting a high degree of accuracy with respect to the members within a group, but the collection process itself is both very efficient and inexpensive.

To illustrate the concept, the computer and network based social media allows individuals having a high risk activity, such as sky-diving, to connect online forming a community of individuals having a common but very risky hobby. These communities permit the sharing of experiences, concerns, dangers, safety practices, upcoming events and a nearly inexhaustible list of other attributes regarding sky-diving.

Normally, insurance for sky-diving is very difficult to obtain or prohibitively expensive. On an individualized basis, it is a risk that is nearly impossible to quantify—and thus insurers avoid writing policies or price it at a default high rate.

The foregoing problems are however avoided by the ad hoc “group” of sky-divers formed by Facebook memberships. In addition to the self selection process, the group communications become an incredibly rich source of group specific data that is highly valuable for underwriting insurance risk. Because the insurance is collected and organized by the individual members at no cost, the resulting pool of data is very accurate, timely and nearly cost free.

Using this “group” as an insurance pool provides the opportunity to offer policies at lower and more sustainable rates. Indeed, the very same web portal becomes a powerful vehicle for distributing and selling group policies to the collective membership—again in a very cost effective manner. Moreover, the groups for which insurance are sought can be completely self-organizing, as a result of the system's leveraging of social networking sites and other sources of data (e.g., mobile phone data, location data, etc.). For example, a previously uninsured activity may be insurable once a group reaches a certain threshold, and applies for group coverage in accordance with the present invention. In one embodiment, buttons or links to apply for group insurance coverage will be made available on group pages of social networking sites.

In a further exemplary embodiment, the insurance system is subscribed to, or otherwise receives updates related to membership data for the group. For example, and not limitation, if the organization portal utilizes a news feed, that feed may be received by the insurance system. Additionally, the insurance system may receive specific activities or other information about the group, which may also be provided by to the insurance system via a feed. Alternatively, the insurance system may automatically check the web data of the group periodically for new data. Even the advertisements targeted to the group provide useful data for better understanding the risk classification and categorization. Further, a person may periodically check the web data, and the insurance system may receive updates from that person.

Given data related to a group's activities and membership, the insurance system may determine an insurance product, which may include a premium fee and a scope of coverage. In some embodiments, a human can view the data related to the group and manually create an insurance product on the insurance system. In some other embodiments, either the premium, of the scope of coverage, both, or other aspects of an insurance product may be automatically calculated by the insurance system based on group data.

In some embodiments, the insurance system may calculate more than one available insurance product, where aspects of the available products are based in part on selection by members of the group. For example, the insurance system may provide a first insurance product with a low premium, a high deductible and minimal coverage scope; a second insurance product with a moderate premium, a low deductible, and moderate coverage scope; and a third insurance product with a high premium, a low deductible and wide coverage scope. Thus, a group member may have multiple options of insurance products offered to the group. In some further embodiments, the insurance system may provide a range of options, where a group member may select a desired premium, deductible, or scope, and the insurance system may calculate the remaining aspects of the insurance product based on the selections and the available insurance products for the group.

The insurance system may provide various means by which a group member may become insured. For example, and not limitation, the insurance system may comprise or otherwise be associated with a website. The website may be in communication with a database comprising data related to the one or more insurance products associated with the group, or the website may comprise code for calculating aspects of an insurance product on demand. A group member may utilize the website to view data about insurance products related to his or her group, and may sign up for, or request coverage under, an insurance product via the website.

In some embodiments, the insurance system may provide a web interface with a predetermined library of operations. Thus, using the library, a website specific to the group, and managed by the group, may access the insurance system through the provided web interface. The group website may thereby provide insurance quotes to an individual in the group. In some instances, the insurance system may implement one or more application programming interfaces (APIs) that are made available to the group. This allows the group to connect to the insurance system using these one or more APIs to obtain insurance quotes and other information associated with products made available to the group by the insurance provider. The insurance system may also provide a module or other application via a social media site to provide a virtual mode for existing services provided by the insurance system. Through this module, an individual in the group may evaluate any insurance products made available to the group.

The insurance system may further include an administrative or customer support module. This module may enable a representative of an insurance provide, associated with the insurance system, to manage insurance coverage. The administrative module may provide various operations. For example, and not limitation the module may accept input from the representative to manage or modify insurance products, approve requested coverage, request additional information, or perform other actions; the module may transmit approvals to group members; or the module may transmit requests for additional information to group members.

The invention described above may be operational with one or more general purpose or special purpose computing system environments or configurations. Examples of well-known computing systems, environments, or configurations that may be suitable for use with the invention include, but are not limited to: personal computers, server computers, hand-held or laptop devices, tablet devices, smartphones, multiprocessor systems, microprocessor-based systems, set top boxes, programmable consumer electronics, household and commercial appliances, vehicles and other networked transportation systems, network personal computers, minicomputers, mainframe computers, distributed computing environments that include the above systems or devices, and the like.

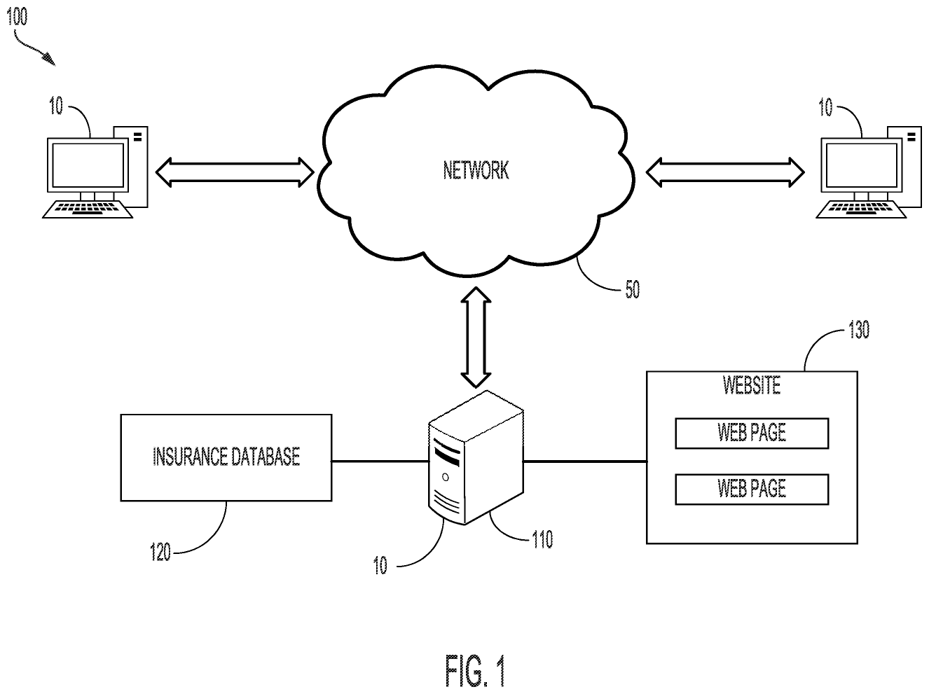

FIG. 1 illustrates a computing environment 100 in which an insurance system or method may be implemented, according to an exemplary embodiment. As shown in FIG. 1, various embodiments of the insurance systems and methods may operate on one or more computer systems 10 and, in some embodiments, may communicate over a network 50. For example, and not limitation, an insurance server 110 may be a computer system 10 in communication with an insurance database 120. The insurance server 110 may thus perform various operations of the invention and may communicate information about insurance products to one or more client computer systems 10 over the network 50. In some cases, the client computer systems 10 may communicate with the insurance server 110 via a website 130 provided at least in part by the server 110.

Components of an exemplary computer system 10 may include, but are not limited to, an input device or devices, an output device or display, a processing unit, a system memory, and a system bus that couples various system components including the system memory, processing unit, and input and output devices. The system bus may be one or more of several types of bus structures, including a memory bus or memory controller, a peripheral bus, and a local bus using at least one of a variety of bus architectures.

The computer system 10 typically includes a connection or access to a variety of non-transitory computer-readable media. Computer-readable media may be available media accessible by the computer and may include volatile or nonvolatile media, and removable or non-removable media. By way of example, and not limitation, computer-readable media may comprise computer storage media and communication media. Computer storage media may store information such as computer-readable instructions, data structures, program modules or other data. Computer storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, networked or “cloud” storage, or other medium that can be used to store the desired information and that may be accessed by the computer. Communication media typically embodies computer-readable instructions, data structures, program modules, or other data in a modulated data signal and includes information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, or other wireless media. Various combinations of the above may also be included within the scope of computer-readable media.

As shown in FIG. 1, the computer system 10 may operate in a networked environment using logical connections to one or more remote computers. Each remote computer may be a personal computer, server, router, hand-held or laptop device, tablet device, smartphone, multiprocessor system, microprocessor-based system, set-top box, programmable consumer electronic, household or commercial appliance, vehicle or other networked transportation system, or peer device or other common network node, and may typically include many or all of the elements described above relative to the computer system. The network 50 may comprise one or more of local area networks (LAN) or wide area networks (WAN), but may also include other networks such as cellular and digital wireless networks. Such networking environments are commonplace in offices, enterprise-wide computer networks, intranets, and the Internet.

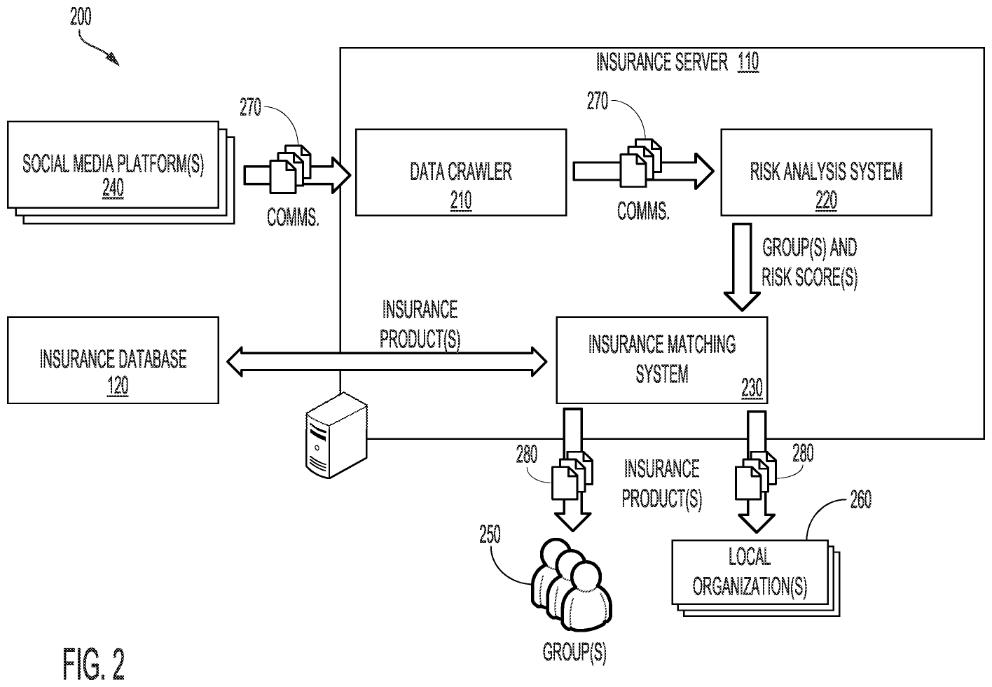

FIG. 2 illustrates a computing environment 200 that includes an insurance server 110. In general, the insurance server 110 accesses communications 270 from one or more social media platforms 240 to identify a set of groups 250, and presents insurance products can be presented, according to one or more exemplary embodiments.

In the computing environment 200, the insurance server includes a data crawler 210 that obtains communications 270 from one or more social media platforms 240. The insurance server 110 also identifies a set of ad hoc groups based on the communications 270 and presents insurance products 280 to members of the ad hoc groups. The insurance server 110 implements the data crawler 210 using a resident computer system or it implements data crawler 210 as an executable software application. The data crawler 210 may subscribe to the one or more social media platforms 240 to access social media data or communications 270. For example, data crawler 210 systematically browses the social media platforms 240 to obtain communications 270 associated with respective users. The communications 270 can include, for example, publicly available user profiles, user images, user group membership information, user comments, user posts, likes, check-ins, memes, and so on. The communications 270 can also include social media data associated with pre-defined groupings of users (e.g., group pages, comments and posts generated within group pages, group page membership information, etc.).

Alternatively, if one or more social media platforms 240 are implemented as applications installed on a myriad of user devices, the data crawler 210 may transmit one or more application programming interface (API) calls to these applications to access and obtain these communications 270. The one or more social media platforms 240 may include any platform that allows users to engage in social networking with other users, such as Facebook, Twitter, LinkedIn, and so on.

In an embodiment, in addition to obtaining communications from one or more social media platforms 240, the data crawler 210 may obtain data from other sources that may be conducive in identifying one or more risk factors for the ad hoc groups to be identified. For instance, the data crawler 210 may obtain data from one or more news organizations (e.g., news reports, weather forecasts, etc.), product manufacturers (e.g., new product offerings, safety recalls, consumer reviews, etc.), retail sites (e.g., product sales, product returns, consumer reviews, etc.), and the like. The data garnered from these additional sources may be used to further identify the one or more ad hoc groups and to identify any risk factors for these one or more ad hoc groups.

The data crawler 210 may obtain communications 270 from the one or more social media platforms 240 and other sources (e.g., mobile telephone service providers, Global Positioning System (GPS) devices, web browsers, virtual assistants, voice services, health records, marketing data, self-reported data, data purchased from third-party services, etc.) periodically and/or in response to triggering events. For instance, the data crawler 210 may access the one or more social media platforms 240 and other sources at pre-defined intervals to obtain the communications 270 available via these one or more social media platforms 240 and other sources. Additionally, or alternatively, the data crawler 210 may access the one or more social media platforms 240 and other sources in response to an event (e.g., an upcoming activity, announcement of a product safety recall, announcement of an accident, a breaking news report, etc.). For example, the data crawler 210 may be subscribed to a news feed, whereby the data crawler 210 may monitor the news feed to identify any events that may warrant identification of groups that may be impacted by these events. As an illustrative example, if an event associated with a skydiving accident is detected by the data crawler 210, the data crawler 210 may obtain communications 270 from the one or more social media platforms 240 and other sources to allow for identification of groups that may be associated with skydiving activities. The data crawler 210 may be programmed to identify these triggering events, such as through identification of particular keywords, monitoring of particular sources (e.g., news organizations, consumer advocacy organizations, etc.), and the like.

The data crawler 210 may provide the communications 270 obtained from the one or more social media platforms 240 and other sources to a risk analysis system 220 of the insurance server 110. The risk analysis system 220 may be implemented using a computer system of the insurance server 110 or as a software application executed by the insurance server 110 to perform the operations described herein. In an embodiment, the risk analysis system 220 utilizes one or more machine learning algorithms and/or artificial intelligence to parse the obtained communications 270 to identify one or more ad hoc groups from portions of the communications 270 and to which different insurance products may be presented. The one or more machine learning algorithms and/or artificial intelligence may be trained using unsupervised learning techniques. For instance, a dataset of social media posts, comments, and other content (e.g., images, memes, etc.) may be analyzed using a clustering algorithm to identify one or more ad hoc groups that include users that share one or more characteristics. As an example, the clustering algorithm may identify an ad hoc group that comprises users sharing an interest or that engage in skydiving. The ad hoc group may be identified based on comments and/or posts by these users that indicate an affinity for skydiving. The ad hoc group may also be identified based on a self-selection process, such as user membership in a group maintained by a social media platform. For instance, the clustering algorithm may generate an ad hoc group that includes members of affinity groups within a social media platform associated with the one or more characteristics of the ad hoc group. Example clustering algorithms that may be trained using sample data (e.g., historical posts and comments, hypothetical posts and comments, etc.) to identify different ad hoc groups may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like.

In additional to identifying different ad hoc groups based on the communications 270 obtained from the data crawler 210, the risk analysis system 220 may calculate a level of risk or risk score for each ad hoc group. For instance, the risk analysis system 220 may further evaluate the portion of the communications that is associated with a particular ad hoc group to generate a risk profile for the various members of the ad hoc group. The risk analysis system 220 may utilize a machine learning algorithm and/or artificial intelligence to determine the behavior and attitudes of the ad hoc group. For instance, the machine learning algorithm and/or artificial intelligence may utilize the portion of the communications generated by the members of the ad hoc group within the context of the one or more characteristics of the ad hoc group, along with other information that may be relevant to the ad hoc group (e.g., product information, product safety recall notifications, news stories and events, upcoming events, etc.), to determine the behavior and attitudes of the members of the ad hoc group.

As an illustrative example, if an ad hoc group is formed based on users' affinity for skydiving in a particular region, the risk analysis system 220, using the machine learning algorithm and/or artificial intelligence, may evaluate the various comments and posts generated by these users that may be related to skydiving in the particular region. This may include comments and posts related to prior skydiving events, upcoming skydiving events, news stories related to skydiving, products related to skydiving, and the like. The machine learning algorithm and/or artificial intelligence may cluster these comments and posts based on indices of risk related to skydiving. For instance, comments and/or posts indicating an indifference to proper safety procedures, to product safety recalls, to negative events associated with skydiving (e.g., skydiving accidents, skydiving equipment failures, etc.) may be classified as being indicative of a high risk factor for the ad hoc group. Alternatively, comments and/or posts indicating adherence to proper safety procedures, to product safety recalls, and the like may be classified as being indicative of a low risk factor for the ad hoc group. Other factors may be utilized in determining the risk score for an ad hoc group, such as the location of the group activity, the type or category of activity, the frequency in which the members of the ad hoc group partake in the group activity, the knowledge base of the members of the ad hoc group, and the like.

In an embodiment, the risk analysis system 220 further determines a level of risk or risk score for each individual member of an ad hoc group. For instance, the risk analysis system 220 may evaluate the comments and posts generated by each member of an ad hoc group to determine a set of characteristics of each member. For instance, the risk analysis system 220, using a machine learning algorithm and/or artificial intelligence, may identify a user's attitudes or behaviors with regard to the category of activity of the ad hoc group. As an illustrative example, if a user expresses, via one or more posts and/or comments via a social media platform, that it does not take the necessary safety precautions when engaging in the activity, the risk analysis system 220 may determine that the user is engaged in risky behavior that may make it more difficult or expensive to insure. Similarly, if the user expresses a lack of knowledge when it comes to the activity, the risk analysis system 220 may determine that the user is at a higher risk of harm resulting from engagement in the activity. As another example, if a user does not purchase equipment best suited for the particular category of activity or otherwise uses equipment that is not rated favorably or is subject to one or more recalls, the risk analysis system 220 may determine that the user is at a higher risk of harm resulting from engagement in the activity. As yet another example, if a user is known, based on obtained data (e.g., Global Positioning System (GPS) data, social media posts/comments, etc.), to engage in the category of activity at locations that are not rated favorably or have received a negative assessment from accreditation agencies for the category of activity, the risk analysis system 220 may determine that the user is at a higher risk of harm. Thus, the risk analysis system 220 may determine, based on a subset of the portion of communications that corresponds to an individual user, a behavioral risk metric for the individual user. This behavior risk metric may be used to identify which insurance products and/or options may be offered to an individual user in addition to, or as an alternative to, the insurance products and/or options offered to the ad hoc or affinity group.

In some instances, for each member of an ad hoc group, the risk analysis system 220 may consider external sources of information to further refine the risk profile for the member engaging in the activity associated with the ad hoc group. For instance, the risk analysis system 220 may evaluate posts or comments made by a member of the ad hoc group that may be unrelated to the activity or context of the ad hoc group. These unrelated posts or comments may be used to identify other risk factors for a member of the ad hoc group. For example, if a member of the ad hoc group has generated posts or comments that indicate a propensity to maintain an unhealthy lifestyle or that it engages in other risky activities, the risk analysis system 220 may assign, to the member of the ad hoc group for the corresponding activity, a risk score that indicates a greater risk of harm for the member. Thus, in addition to defining a risk score for the ad hoc group in general, the risk analysis system 220 may also define a risk score for each member of the ad hoc group. In some instances, the risk score for the ad hoc group may be calculated using the individual member risk scores as a variable or factor in the risk score calculation.

The risk analysis system 220 may provide information regarding each ad hoc group (e.g., members of the ad hoc group, activities associated with the ad hoc group, region information of the ad hoc group, etc.), as well as the level of risk or risk score calculated for the ad hoc group and its corresponding members, to an insurance matching system 230 of the insurance server 110. The insurance matching system 230 may be implemented using a computer system of the insurance server 110 or as a software application executed by the insurance server 110 to perform the operations described herein. In some instances, the risk analysis system 220 may also provide the aforementioned information regarding each ad hoc group and the level of risk or risk score calculated for the ad hoc group and its corresponding members to one or more other services. For example, the risk analysis system 220 may provide this information to another service or system that provides other insurance products to its customers. For instance, if a member of an ad hoc group accesses one or more other services to apply for a separate life insurance product, the one or more other services may use the risk score for the member calculated by the group risk scoring sub-system to determine which life insurance products may be available to the member, as well as the cost to the member for obtaining any of the available life insurance products.

The insurance matching system 230, in an embodiment, accesses an insurance database 120 to identify one or more insurance products 280 for each identified ad hoc group, as well as its corresponding members, based on the calculated risk scores for the ad hoc group and its corresponding members. The insurance database 120 may include entries corresponding to different insurance products offered by an insurance provider. Each entry in the insurance database 120 may be associated with a risk score or range of risk scores for which the corresponding insurance product may be offered. Further, the entry may specify a cost for the corresponding insurance product based on the risk score and other factors (e.g., location, category of activity, term, insurance benefit, etc.).

Using the insurance database 120, the insurance matching system 230 may identify, for a particular ad hoc group and based on the risk score for the ad hoc group, one or more available insurance products that may be offered to the ad hoc group. For instance, if the ad hoc group is associated with an upcoming activity, the insurance matching system 230 may identify an activity-specific insurance product to the members of the ad hoc group. As another example, if the ad hoc group is associated with a particular hobby or activity that the members of the ad hoc group regularly engage in, the insurance matching system 230 may identify, from the insurance database 120 and based on the risk score for the ad hoc group, different insurance products that may be specific to the activity or otherwise are associated with the risk factors of the activity. This may include life insurance products, disability insurance products, insurance products specific to the activity or hobby (e.g., property, casualty, etc.), and the like.

In an embodiment, the insurance matching system 230 obtains, from other insurance providers, information regarding insurance products offered by these other insurance providers. This information may be used in conjunction with the information obtained from the insurance database 120 to identify the insurance products 280 that may be offered to an ad hoc group and to each member of the ad hoc group. For instance, the insurance matching system 230 may determine which insurance products identified from the insurance database 120 are competitive compared to those offered by competing insurance providers. From these determined insurance products, the insurance matching system 230 may determine whether competitive rates for these insurance products may be provided to the ad hoc group and to the members of the ad hoc group. Thus, the insurance products 280 offered to an ad hoc group and its members may be tailored to provide greater or competitive value compared to the insurance products that may be offered by one or more competitors.

In some instances, the information from other insurance providers may be used to provide greater flexibility in providing different insurance products to an ad hoc group and its members. For instance, if the insurance matching system 230 determines, based on a risk score for a particular ad hoc group, that another insurance provider provides an insurance product that the insurance provider that implements the insurance server 110 would otherwise not provide to the ad hoc group, the insurance matching system 230 may forego making available a similar insurance product to the ad hoc group. For example, if a certain insurance product is made available by another insurance provider for a high risk group, the insurance matching system 230 may avoid bearing this risk by foregoing promotion of a similar insurance product.

In addition to identifying available insurance products for an ad hoc group, the insurance matching system 230 can determine which of these available insurance products are to be made available to each member of the ad hoc group. For instance, if a particular member of the ad hoc group has a risk score that indicates that the member is in a high risk category, the insurance matching system 230 may determine that the insurance products made generally available to the ad hoc group are not to be offered to this particular member. Conversely, if a particular member of the ad hoc group has a risk score that indicates that the member is in a low risk category, the insurance matching system 230 may determine that the member is eligible for other insurance products that may otherwise not be offered to the members of the ad hoc group or to obtain the insurance products being offered to the ad hoc group at a lower cost.

In an embodiment, the insurance matching system 230 determines one or more methods for promoting the insurance products selected for an ad hoc group. For instance, if the ad hoc group corresponds to a pre-defined group maintained by a social media platform, the insurance matching system 230 may generate a post within the pre-defined group maintained by the social media platform to advertise the insurance products selected for the ad hoc group. This post may be tailored to be specific to the pre-defined group and may provide a link or other network address through which members of the ad hoc group may request additional information regarding the selected insurance products, apply for the selected insurance products, or otherwise interact with the insurance provider. If contact information for each member of the ad hoc group (e.g., e-mail addresses, mobile phone number, etc.) is available, the insurance matching system 230 may utilize this contact information to directly advertise or promote the selected insurance products to the members of the ad hoc group. This may allow the insurance matching system 230 to provide, for the particular activity associated with the ad hoc group, tailored insurance products to each member of the ad hoc group subject to the risk score calculated for the member of the ad hoc group.

In addition to promoting the identified insurance products to the ad hoc groups 250, the insurance matching system 230 may promote these identified insurance products and/or other insurance products at local organizations 260 that may be associated with the ad hoc groups 250 or at least proximate to at least one user of the set of users associated with the ad hoc groups 250. For instance, if an ad hoc group is created for an upcoming event at a particular business that is offering the event, the insurance matching system 230 may promote the identified insurance products at the particular business in anticipation of the upcoming event. This may include advertising these insurance products locally using available media (e.g., television advertisements, billboard advertisements, sponsorships, etc.) as well as providing local organizations 260 with an opportunity to promote the insurance products during the upcoming event to participants of the event. As an illustrative example, if an ad hoc group is associated with a skydiving meet at a local skydiving facility, the insurance matching system 230 may advertise the identified insurance products at the local skydiving facility and the surrounding environs in anticipation of the upcoming event. Further, the insurance matching system 230 may engage the skydiving facility to promote the insurance products to individuals appearing at the skydiving meet.

In an embodiment, the insurance matching system 230 uses location information of the set of users associated with an ad hoc group to identify a business or local organization that is at a location proximate to at least one user of the set of users. For instance, communications generated by the set of users may include check-in information that is used to determine the location of the set of users. As an illustrative example, when a user arrives at a particular location, the user may generate a check-in message to indicate that the user is at the particular location. This check-in message may be shared within a social media platform. In some instances, when a user generates a comment or post within a social media platform, the social media platform may obtain geolocation information, such as through a Global Positioning System (GPS) antenna on a user's device, mobile phone tracking, and the like, and associate this geolocation information with the comment or post (e.g., metadata, additional presented content, etc.). This location information may be used to identify any businesses proximate to the set of users that may be offering the category of activity associated with the ad hoc or affinity group.

In an embodiment, the insurance server 110 utilizes the information garnered by the risk analysis system 220 to predict future events and determine how to mitigate risk for members of an ad hoc group or for a local organization. For instance, if the risk analysis system 220 identifies an ad hoc group associated with a future activity or event based on conversations amongst users of the ad hoc group, the insurance server 110 may use the identification of this ad hoc group as an indication of the future activity or event. This information may be utilized by the insurance server 110 to engage any local organizations 260 that may be associated with the future activity or event to prepare for any heightened risks resulting from the future activity or event. This may include offering these local organizations 260 insurance products related to the future activity or event. Further, the insurance server 110 may notify the insurance provider of the future activity or event, which may cause the insurance provider to work with the local organizations 260 to prepare for the future activity or event (e.g., hiring or providing additional staff, ensuring sufficient resources are available to accommodate the future activity or event, addressing any safety issues to reduce risk to users, etc.). In some instances, if the risk analysis system 220 identifies one or more high risk members of an ad hoc group that are likely to partake in the future activity or event, the insurance server 110 may notify these local organizations 260 with regard to these one or more high risk members. This may allow the local organizations 260 to perform any mitigating actions to reduce the risk of hard to these high risk members and to other members of the ad hoc group.

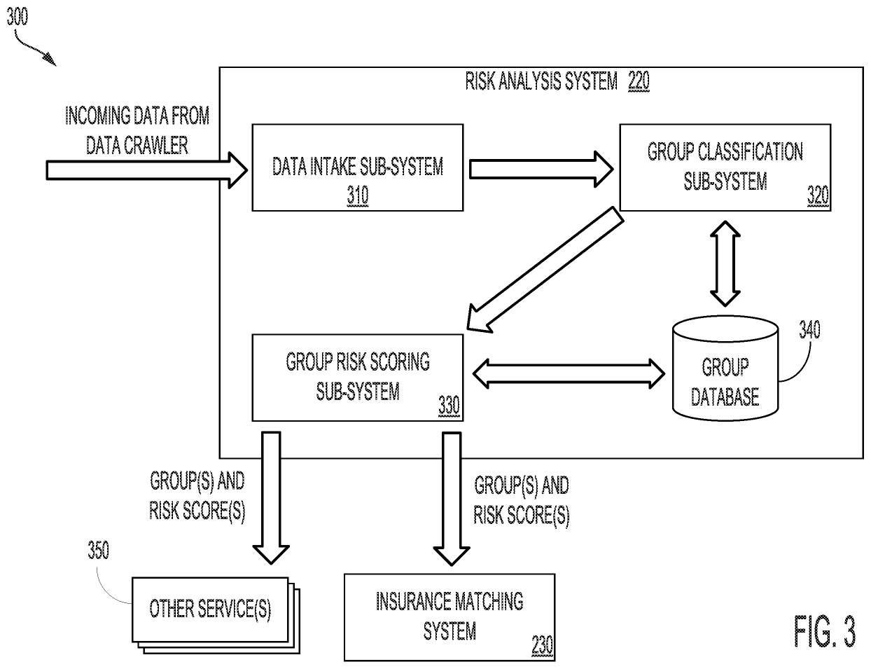

FIG. 3 illustrates a computing environment 300 in which a risk analysis system 220 of an insurance server processes incoming data from a data crawler to identify a set of groups and determines a risk score for each group to be used to identify insurance products for each group, according to one or more exemplary embodiments. In the computing environment 300, a data intake sub-system 310 of the risk analysis system 220 receives incoming data from a data crawler of the insurance server. As noted above, the data crawler may obtain data from one or more social media platforms and from other sources, such as news organizations, product manufacturers, retail sites, and the like. The data crawler may obtain this data periodically or in response to a triggering event. Further, the data crawler may push this obtained data to the data intake sub-system 310 for processing of the data. Alternatively, the data intake sub-system 310 may query the data crawler to obtain the data for processing. The data intake sub-system 310 may be implemented using a computer system of the risk analysis system 220 or as a software application or module executed by the insurance server to perform the operations described herein.

In response to obtaining data from the data crawler, the data intake sub-system 310 may process the data to identify attributes and other characteristics of users of the social media platforms from which the data was obtained. For instance, the data intake sub-system 310 may generate, for each identified user, a user profile that includes the various comments and posts generated by the user via the one or more social media platforms. The data intake sub-system 310 may utilize identifying information of a user to aggregate the user's comments and posts generated via distinct social media platforms and other forums (e.g., website comment sections, etc.) within a single user profile. For instance, if a user utilizes the same e-mail address for accounts with different social media platforms, the data intake sub-system 310 may generate a profile associated with this e-mail address to aggregate the user's comments and posts from these different social media platforms.

In some instances, the data intake sub-system 310 may obtain data from other data sources in order to obtain additional information for each identified user. For instance, the data intake sub-system 310 may obtain, from the data crawler, user information from government agencies, organizations, employers, and the like. For instance, using information obtained from the different social media platforms, the data crawler may query these other data sources to identify any available data associated with the identified users. This additional user information may provide an additional description of the user, as well as additional input regarding the user's behaviors.

In addition to generating user profiles for identified users, the data intake sub-system 310 may further generate group profiles for pre-defined groups within the different social media platforms. For instance, data obtained by the data crawler from a pre-defined group may be aggregated, by the data intake sub-system 310, into a group profile specific to the pre-defined group. In some instances, an organization may maintain a group specific to the organization within different social media platforms. These groups may each share the same or similar name and/or content. As such, the data intake sub-system 310 may aggregate the content from these groups tied to a specific organization within a single group profile for the organization. Thus, the data intake sub-system 310 may perform an initial processing of the data obtained by the data crawler to facilitate classification of the data and identification of ad hoc groups, as described herein.

In an embodiment, the data intake sub-system 310 transmits the user profiles, group profiles, and other data (e.g., comments, posts, images, etc.) associated with these profiles to a group classification sub-system 320 of the risk analysis system 220. Additionally, the data intake sub-system 310 may provide, to the group classification sub-system 320 any other data obtained from the data crawler that may not be inherently associated with a particular user or pre-defined group (e.g., news reports, weather forecasts, new product offerings, safety recalls, product sales, product returns, etc.). The group classification sub-system 320 may be implemented using a computer system of the risk analysis system 220 or as a software application or module executed by the insurance server to perform the operations described herein.

In an embodiment, the group classification sub-system 320 implements one or more machine learning algorithms and/or artificial intelligence to process the incoming profiles and data from the data intake sub-system 310 to generate one or more ad hoc groups that may each be associated with a particular activity/hobby or event. For instance, a dataset of social media posts, comments, and other content (e.g., images, memes, etc.) may be analyzed using a clustering algorithm to identify one or more ad hoc groups that include users that share one or more characteristics. Further, this dataset may be analyzed to determine, for each user associated with the particular activity/hobby or event by virtue of the social media posts, comments, and other contents associated with the particular activity/hobby or event, a metric of interest in the activity/hobby or event. For instance, the group classification sub-system 320 may evaluate the communications identified as being associated with the particular activity/hobby or event to determine, for each user engaged in these communications, an interaction frequency between each user and the communications. Based on this interaction frequency, the group classification sub-system 320 may calculate a metric of interest in the activity/hobby or event for each user. As an illustrative example, if a particular user has expressed minimal interest in the activity/hobby or event (e.g., the user has provided a small number of comments and/or posts related to the activity/hobby or event), the group classification sub-system 320 may calculate a low or minimal metric of interest for the user. However, if a particular user is actively engaged with other users with regard to the activity/hobby or event (e.g., the user has provided a significant number of comments and/or posts related to the activity/hobby or event), the group classification sub-system 320 may calculate a high metric of interest for the user.

The group classification sub-system 320 may apply a metric of interest threshold for selection of users that are to be associated with the particular activity/hobby or event. For instance, if the metric of interest for a particular user exceeds the metric of interest threshold, the group classification sub-system 320 may select the particular user for inclusion in the ad hoc or affinity group associated with the activity/hobby or event. Alternatively, if the metric of interest for a particular user does not exceed this threshold, the group classification sub-system 320 may omit the user from inclusion in the ad hoc or affinity group associated with the activity/hobby or event.

In an embodiment, the group classification sub-system 320 accesses a group database 340 to identify any existing ad hoc or affinity groups that may be associated with the activity/hobby or event. If the group classification sub-system 320 determines that an existing ad hoc or affinity group exists for the activity/hobby or event, the group classification sub-system 320 may incorporate the elements (e.g., selected users, posts and comments, etc.) associated with the identified ad hoc or affinity group with the existing ad hoc or affinity group, thereby updating the group. However, if the ad hoc or affinity group established by the group classification sub-system 320 does not have a corresponding analog in the group database 340, the group classification sub-system 320 may update the group database 340 by adding a new entry corresponding to this new ad hoc or affinity group. The entry may specify the one or more users identified as being members of the ad hoc or affinity group, as well as any content generated by these one or more users that is associated with the corresponding activity/hobby or event (e.g., posts, comments, images, memes, etc.).

The group classification sub-system 320 may transmit the identified ad hoc or affinity groups, including information regarding the users associated with the identified groups and any corresponding content generated and/or shared amongst these users (e.g., posts, comments, images, memes, etc.) to a group risk scoring sub-system 330 of the risk analysis system 220. The group risk scoring sub-system 330 may calculate a risk score for each ad hoc group. For instance, the group risk scoring sub-system 330 may evaluate the content associated with a particular ad hoc group (e.g., posts, comments, images, memes), as well as characteristics of each user associated with the group (e.g., user risk profiles, etc.) to generate a risk profile for the ad hoc group. The group risk scoring sub-system 330 may utilize a machine learning algorithm and/or artificial intelligence to determine the behavior and attitudes of the ad hoc group. For instance, the machine learning algorithm and/or artificial intelligence may utilize the content generated by the users associated with the ad hoc group within the context of the one or more characteristics of the ad hoc group (e.g., content related to the activity/hobby or event associated with the ad hoc group, etc.), along with other information that may be relevant to the ad hoc group (e.g., product information, product safety recall notifications, news stories and events, upcoming events, etc.), to determine the behavior and attitudes of the members of the ad hoc group.

In an embodiment, the group risk scoring sub-system 330 calculates a risk score for each individual member of an ad hoc group. For instance, group risk scoring sub-system 330 may evaluate the comments and posts generated by each member of an ad hoc group to determine a set of characteristics of each member. As noted above, a machine learning algorithm and/or artificial intelligence may be utilized to identify a user's attitudes or behaviors with regard to the shared activity of the ad hoc group. If the group risk scoring sub-system 330 determines that a particular user associated with the ad hoc group represents a greater risk of harm (e.g., user expresses a cavalier attitude towards safety, user frequently ignores safety advice, user engages in other risky activities or behaviors, etc.), the group risk scoring sub-system 330 may assign the user a risk score indicative of a greater risk of injury or harm to the user and others by the user in performance of the associated activity. Alternatively, if the group risk scoring sub-system 330 determines that a particular user associated with the ad hoc group represents a lower risk of harm (e.g., user expresses adherence to safety protocols, user engages in low risk behaviors outside of the activity, user maintains significant knowledge regarding the activity, etc.), the group risk scoring sub-system 330 may assign the user a risk score indicative of a lower risk of injury or harm to the user and others by the user in performance of the associated activity.

As noted above, for each member of an ad hoc group, external sources of information may be considered to further refine the risk profile for each user engaging in the activity associated with the ad hoc group. For instance, the group risk scoring sub-system 330 may evaluate posts or comments made by a user associated with the ad hoc group that may be unrelated to the activity/hobby or event associated with the ad hoc group. These unrelated posts or comments may be used to identify other risk factors for a user associated with the ad hoc group. For example, if a user associated with the ad hoc group has generated posts or comments that indicate a propensity to maintain an unhealthy lifestyle or that it engages in other risky activities, the group risk scoring sub-system 330 may assign, to this user, a risk score that indicates a greater risk of harm for the user. Thus, in addition to defining a risk score for the ad hoc group in general, the group risk scoring sub-system 330 may also define a risk score for each user associated with the ad hoc group. In some instances, the risk score for the ad hoc group may be calculated using the individual member risk scores as a variable or factor in the risk score calculation.

The group risk scoring sub-system 330 may store the calculated risk score for each identified ad hoc or affinity group, as well as the calculated risk score for each user associated with an ad hoc or affinity group, within the group database 340. As additional content associated with an ad hoc or affinity group is obtained, the group risk scoring sub-system 330 may evaluate this additional content to determine whether to modify the risk score for the ad hoc or affinity group. For instance, for an ad hoc or affinity group, the group risk scoring sub-system 330 may determine whether a risk score was previously calculated. If so, the group risk scoring sub-system 330 may process any new content for the ad hoc or affinity group, along with any previously obtained content, to calculate a new risk score for the ad hoc or affinity group. If the new risk score differs from the previously calculated risk score, the group risk scoring sub-system 330 may assign this new risk score to the ad hoc or affinity group and update the group database 340 accordingly. This new risk score may result in different insurance products being made available to the users associated with the ad hoc or affinity group, as described herein. In some instances, previously presented insurance products may be removed or otherwise made to be no longer available to the users with the ad hoc or affinity group. In other instances, based on the new risk score, additional insurance products may be made available to the users associated with the ad hoc or affinity group.

The group risk scoring sub-system 330 may provide information regarding each ad hoc group (e.g., users associated with the ad hoc group, activities associated with the ad hoc group, region information of the ad hoc group, etc.), as well as the risk score calculated for the ad hoc group and its corresponding users, to an insurance matching system 230, as described above. The insurance matching system 230 may access an insurance database to identify one or more insurance products 280 for each identified ad hoc group, as well as its corresponding users, based on the calculated risk scores for the ad hoc group and its corresponding users. In addition to identifying available insurance products for an ad hoc group, the insurance matching system 230 can determine which of these available insurance products are to be made available to each user associated with the ad hoc group.

In some instances, the group risk scoring sub-system 330 may also provide the information regarding each ad hoc group and the risk score calculated for each ad hoc group and its corresponding users to one or more other services 350. The one or more other services 350 may include other insurance systems or external systems that may provide other insurance related needs to these ad hoc groups and their corresponding users. For example, the group risk scoring sub-system 330 may provide this information to another service or system that provides other insurance products to its customers. For instance, if a member of an ad hoc group accesses one or more other services 350 to apply for a separate life insurance product, the one or more other services 350 may use the risk score for the member calculated by the group risk scoring sub-system 330 to determine which life insurance products may be available to the member, as well as the cost to the member for obtaining any of the available life insurance products.

As noted above, the insurance matching system 230 can determine one or more methods for promoting the selected insurance products to the users associated with the ad hoc or affinity group. For instance, if an ad hoc or affinity group is associated with a pre-defined group within a social media platform, the insurance matching system 230 may generate targeted advertisements that may be posted to the pre-defined group within the social media platform environment. The targeted advertisements may include one or more links to a webpage or other content provided by an insurance provider. The webpage or other content may be specific to the ad hoc or affinity group and may include an offer or solicitation for the selected insurance products. In some instances, if contact information is available for one or more users associated with the ad hoc or affinity group, the insurance matching system 230 may transmit targeted advertisements directly to these users via the provided contact information.

The insurance matching system 230 may additionally promote the identified insurance products at local organizations that may be associated with the activity/hobby or event associated with the ad hoc or affinity group. For instance, if an ad hoc group is created for an upcoming event at a particular location, the insurance matching system 230 may promote the identified insurance products at the particular location in anticipation of the upcoming event. This may include advertising these insurance products locally using available media (e.g., television advertisements, billboard advertisements, sponsorships, etc.) as well as providing local organizations with an opportunity to promote the insurance products during the upcoming event to participants of the event.

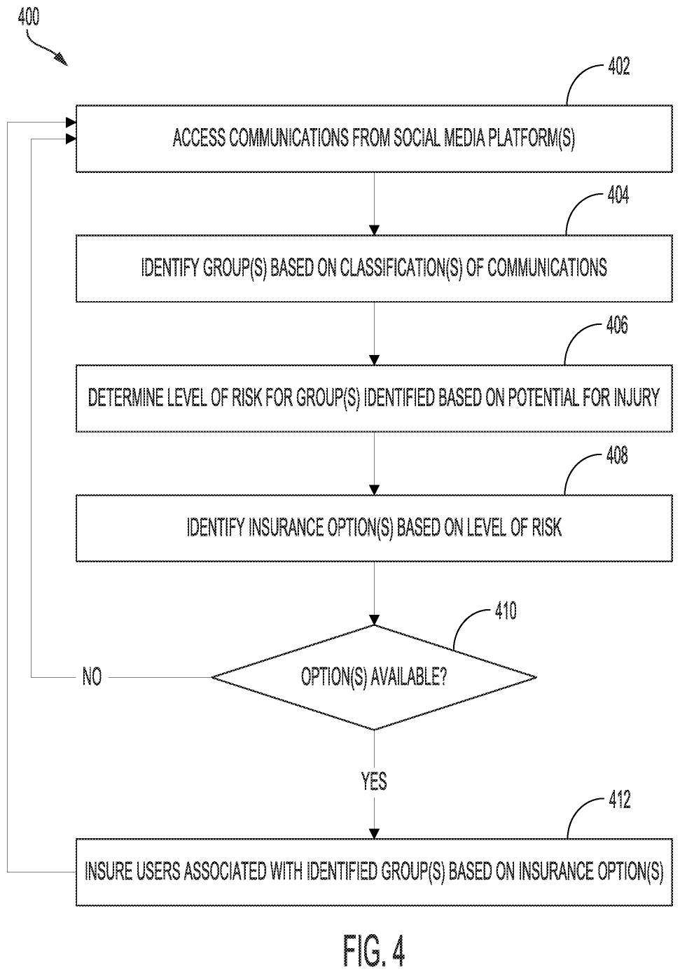

FIG. 4 illustrates a process 400 for identifying a set of groups based on data obtained from one or more social media platforms and determining insurance products that can be presented to each group, according to one or more exemplary embodiments. The process 400 may be performed by the various components of the insurance server, including the data crawler, risk analysis system, and the insurance matching system described above in connection with FIG. 2.

At step 402, the insurance server accesses communications from one or more social media platforms. For instance, using a data crawler, the insurance server may access one or more social media platforms to retrieve communications generated by users of the one or more social media platforms. These communications may include comments, posts, pictures, memes, and other content that may be shared amongst users of the one or more social media platforms. In addition to obtaining communications from the one or more social media platforms, the data crawler may obtain information corresponding to pre-defined groups maintained by the one or more social media platforms. This may include any salient information regarding the pre-defined groups (e.g., any associated affinities, the category of activity, user membership rolls, etc.) as well as associations between content shared within the pre-defined groups and the pre-defined groups themselves. In some instances, the data crawler may obtain data from other sources that may provide additional context for a particular category of activity. For instance, the data crawler may obtain data from one or more news organizations (e.g., news reports, weather forecasts, etc.), product manufacturers (e.g., new product offerings, safety recalls, consumer reviews, etc.), retail sites (e.g., product sales, product returns, consumer reviews, etc.), and the like. This data may be used to further identify the one or more ad hoc groups and to identify any risk factors for these one or more ad hoc groups.

At step 404, the insurance server identifies one or more ad hoc or affinity groups based on classifications of portions of the communications. As noted above, the insurance server, via a risk analysis system, implements machine learning algorithms and/or artificial intelligence to process the communications from the data crawler to generate one or more ad hoc groups that may each be associated with a category of activity or event. For instance, a dataset of social media posts, comments, and other content (e.g., images, memes, etc.) may be analyzed using a clustering algorithm to identify one or more ad hoc groups that include users that share one or more characteristics. Further, this dataset may be analyzed to determine, for each user associated with the category of activity or event by virtue of the social media posts, comments, and other contents associated with the category of activity or event, a metric of interest in the category of activity or event. For instance, the risk analysis system may evaluate the portion of the communications identified as being associated with the category of activity or event to determine, for each user engaged in these communications, an interaction frequency between each user and the portion of the communications. Based on this interaction frequency, the risk analysis system may calculate a metric of interest in the category of activity or event for each user. The risk analysis system may utilize this metric of interest to select the users that are to be part of the ad hoc or affinity group for the category of activity or event.

At step 406, the insurance server determines a level of risk (e.g., risk score, etc.) for each of the one or more ad hoc or affinity groups identified based on the potential for injury stemming from their respective category of activity. For instance, the insurance server, via the risk analysis system, may evaluate the portion of the communications associated with a particular ad hoc group (e.g., posts, comments, images, memes), as well as characteristics of each user associated with the group (e.g., user risk profiles, etc.) and characteristics of the category of activity (e.g., potential for injury during performance of the activity, etc.) to generate a risk profile for the ad hoc group. The risk analysis system may utilize the portion of the communications generated by the users associated with the ad hoc group within the context of the one or more characteristics of the ad hoc group (e.g., content related to the activity/hobby or event associated with the ad hoc group, etc.), along with other information that may be relevant to the ad hoc group (e.g., product information, product safety recall notifications, news stories and events, upcoming events, etc.), to determine the behavior and attitudes of the members of the ad hoc group.

At step 408, the insurance server identifies one or more insurance options for each ad hoc or affinity group based on the corresponding level of risk. The insurance server, via an insurance matching system, may access an insurance database to identify one or more insurance products for each identified ad hoc group, as well as its corresponding users, based on the calculated risk scores for the ad hoc group and its corresponding users. In addition to identifying available insurance products for an ad hoc group, the insurance matching system can determine which of these available insurance products are to be made available to each user associated with the ad hoc group. For instance, if a particular user is assigned a level of risk that represents a different potential for injury compared to the ad hoc or affinity group in general, the insurance matching system may identify a different set of insurance products that may be offered to the user or alternative pricing for insurance products to be offered to the ad hoc or affinity group. In some instances, if the level of risk is too severe (e.g., the risk of harm is substantial or exceeds a threshold), the insurance matching system may determine that no insurance options are available for the ad hoc or affinity group. Thus, based on the level of risk, the insurance matching system, at step 410, determines whether there are any insurance products or other options available to the ad hoc or affinity group.

If the insurance server determines that there are no insurance products or options available to an ad hoc or affinity group, the insurance server may continue to process incoming communications from the one or more social media platforms, thereby restarting the process 400. However, if the insurance server identifies one or more insurance products or options that may be offered to the users associated with an ad hoc or affinity group, the insurance server, at step 412, insures these users based on the identified one or more insurance products or options. In this context, insuring these users may include generating targeted advertisements that may be presented to these users. For instance, the insurance server may transmit these targeted advertisements to each user by utilizing contact information available for each user. Additionally, or alternatively, if the users associated with an ad hoc or affinity group are members of a pre-defined group within a social media platform, the insurance server may generate a targeted advertisement that may be presented to these users via a post within the pre-defined group. In some instances, if the ad hoc or affinity group is associated with a particular location that offers the particular activity, the insurance server may target the location with one or more advertisements. These advertisements may include information regarding the one or more insurance products or options.

In addition to providing targeted advertisements for the one or more insurance products or options, the insurance server may provide the users associated with an ad hoc or affinity group with an application to obtain any of the one or more insurance products or options. For instance, a targeted advertisement may include a link to a website through which a user may complete an application for any of the one or more insurance products or options. The insurance server may evaluate the application and determine whether to grant the user with the insurance product or option selected by the user.

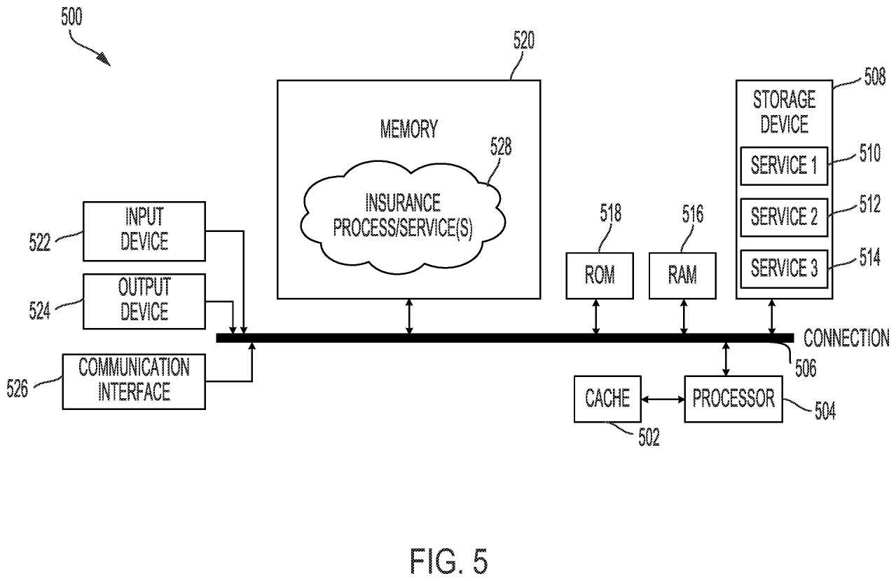

FIG. 5 illustrates a computing system architecture 500. The computing system architecture 500 includes various components in electrical communication with each other using a connection 506, such as a bus, in accordance with some implementations. System architecture 500 also includes a processing unit (CPU or processor) 504 and a system connection 506 that couples various system components including the system memory 520, such as ROM 518 and RAM 516, to the processor 504. The system architecture 500 can include a cache 502 of high-speed memory connected directly with, in close proximity to, or integrated as part of the processor 504. The system architecture 500 can copy data from the memory 520 and/or the storage device 508 to the cache 502 for quick access by the processor 504. In this way, the cache can provide a performance boost that avoids processor 504 delays while waiting for data. These and other modules can control or be configured to control the processor 504 to perform various actions.

Computing system architecture 500 also includes memory 520, which can represent multiple different types of memory with different performance characteristics. The processor 504 can include any general purpose processor and a hardware or software service, such as service 510, service 512, and service 514 stored in storage device 508, configured to control the processor 504 as well as a special-purpose processor where software instructions are incorporated into the actual processor design. The processor 504 may be a completely self-contained computing system, containing multiple cores or processors, a bus, memory controller, cache, etc. A multi-core processor may be symmetric or asymmetric.

System memory 520 may further comprise a plurality of storage locations that are addressable by processor 504 for storing software programs and data structures associated with the embodiments described herein. Processor 504 may comprise necessary elements or logic adapted to execute the software programs and manipulate data structures. An operating system, portions of which are typically resident in memory 520 and executed by processor 504, functionally organizes the device by, inter alia, invoking operations in support of software processes and/or services executing on the device. These software processes and/or services may comprise an illustrative “insurance” process/service 528, as described herein. Note that while process/service 528 is centrally shown in memory 520, some embodiments provide for these processes/services to be operated in a distributed computing network.

It will be apparent to those skilled in the art that other processor and memory types, including various computer-readable media, may be used to store and execute program instructions pertaining to the techniques described herein. For example, the techniques described herein may be performed by hardware, software, and/or firmware, such as in accordance with the illustrative insurance process 528, which may contain computer executable instructions executed by the processor 504 to perform functions relating to the techniques described herein. Also, while this disclosure describes various processes, it is expressly contemplated such processes may be embodied as modules configured to operate in accordance with the techniques herein (e.g., according to the functionality of a similar process). Further, while the processes have been shown separately, those skilled in the art will appreciate that processes may be routines or modules within other processes. For example, processor 504 can include one or more programmable processors, e.g., microprocessors or microcontrollers, or fixed-logic processors. In the case of a programmable processor, any associated memory, e.g., memory 520, may be any type of tangible processor readable memory, e.g., random access, read-only, etc., that is encoded with or stores instructions that can implement program modules. Processor 504 can also include a fixed-logic processing device, such as an application specific integrated circuit (ASIC) or a digital signal processor that is configured with firmware comprised of instructions or logic that can cause the processor to perform the functions described herein. Thus, program modules may be encoded in one or more tangible computer readable storage media for execution, such as with fixed logic or programmable logic, e.g., software/computer instructions executed by a processor, and any processor may be a programmable processor, programmable digital logic, e.g., field programmable gate array, or an ASIC that comprises fixed digital logic, or a combination thereof. In general, any process logic may be embodied in a processor or computer readable medium that is encoded with instructions for execution by the processor that, when executed by the processor, are operable to cause the processor to perform the functions described herein.

To enable user interaction with the computing system architecture 500, an input device 522 can represent any number of input mechanisms, such as a microphone for speech, a touch-sensitive screen for gesture or graphical input, keyboard, mouse, motion input, speech and so forth. An output device 524 can also be one or more of a number of output mechanisms known to those of skill in the art. In some instances, multimodal systems can enable a user to provide multiple types of input to communicate with the computing system architecture 500. The communications interface 526 can generally govern and manage the user input and system output. There is no restriction on operating on any particular hardware arrangement and therefore the basic features here may easily be substituted for improved hardware or firmware arrangements as they are developed.

Storage device 508 is a non-volatile memory and can be a hard disk or other types of computer readable media which can store data that are accessible by a computer, such as magnetic cassettes, flash memory cards, solid state memory devices, digital versatile disks, cartridges, RAMs 516, ROM 518, and hybrids thereof.

The storage device 508 can include services 510, 512, 514 for controlling the processor 504. Other hardware or software modules are contemplated. The storage device 508 can be connected to the system connection 506. In one aspect, a hardware module that performs a particular function can include the software component stored in a computer-readable medium in connection with the necessary hardware components, such as the processor 504, connection 506, output device 524, and so forth, to carry out the function.

For ease of exposition, not every step or element of the present invention is described herein as part of software or a computer system, but those skilled in the art will recognize that each step or element may have a corresponding computer system or software component. Such computer systems and software components are therefore enabled by describing their corresponding steps or elements (that is, their functionality), and are within the scope of the insurance systems and methods. In addition, various steps or elements of the insurance systems and methods may be stored in one or more non-transitory storage media and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after development of the present invention.

The techniques herein provide an insurance server that evaluates communications from one or more social media platforms as well as datasets from various sources to identify ad hoc or affinity groups to which various insurance products may be presented. These techniques provide a scalable solution to identify levels of risk for each of these identified groups and identify appropriate insurance products and options based on their corresponding levels of risk. The techniques are flexible and can provide users with insurance products and options that otherwise may not have been previously available based solely on the inherent risk associated with a given category of activity. Thus, by evaluating the actual communications amongst users, as well as evaluating the category of activity that these users are engaged in, additional context can be used to provide tailored insurance products and solutions.

While there have been shown and described illustrative embodiments and processes executed by an insurance server, it is to be understood that various other adaptations and modifications may be made within the spirit and scope of the embodiments herein. For example, the embodiments have been shown and described herein with relation to one insurance server; however, the embodiments in their broader sense are not as limited, and may, in fact, be used with any number of servers, devices, systems, and the like.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly this description is to be taken only by way of example and not to otherwise limit the scope of the embodiments herein. Therefore, it is the object of the appended claims to cover all such variations and modifications as come within the true spirit and scope of the embodiments herein.

1. A method, comprising:
accessing communications from at least one social media platform, the communications including at least one of text data or image data;
determining a portion of the communications corresponds to a category of activity;
determining a level of risk for the category of activity based on a potential for injury;
identifying at least one insurance product based on the level of risk for the category of activity;
identifying a set of users associated with the portion of the communications; and
insuring the set of users for the category of activity based on the at least one insurance product.

2. The method of claim 1, further comprising:
generating one or more advertisements to provide information regarding the at least one insurance product; and
providing the one or more advertisements to the set of users over the social media platform.

3. The method of claim 1, further comprising:
identifying a business at a location proximate to at least one user of the set of users based on the portion of the communications, the business offering the activity; and
targeting the business with one or more advertisements to provide information regarding the at least one insurance product.

4. The method of claim 1, wherein accessing the communications from the at least one social media platform further comprises at least one of crawling data from the social media platform to obtain the communications or sending an Application Program Interface (API) message to obtain the communications.

5. The method of claim 1, wherein identifying the set of users further comprises:
identifying each user associated with the portion of the communications;
determining, for each user, a metric of interest in the category of activity based on an interaction frequency between each user and the portion of the communications; and
selecting one or more users to form the set of users based on the metric of interest in the category of activity for each user.

6. The method of claim 1, further comprising:
identifying a subset of the portion of communications that corresponds to an individual user; and
determining a behavioral risk metric for the individual user based on characterizations of the category of the activity by the subset of the portion of communications, and
wherein insuring the set of users for the category of the activity further comprises insuring the individual user based on the behavioral risk metric.

7. The method of claim 1, wherein determining the portion of the communications corresponds to the category of activity further comprises:
inputting sample communications as training data into a machine learning algorithm, wherein the sample communications correspond to the category of activity; and
analyzing, by the machine learning algorithm, the communications from the at least one social media platform to determine the portion of the communications corresponds to the category of activity.

8. The method of claim 1, wherein the set of users form an affinity group associated with the category of activity.

9. A system, comprising:
one or more processors; and
memory configured to store instructions, the instructions, when executed by the one or more processors, are operable to:
access communications from at least one social media platform, the communications including at least one of text data or image data;
determine a portion of the communications corresponds to a category of activity;
determine a level of risk for the category of activity based on a potential for injury;
identify at least one insurance product based on the level of risk for the category of activity;
identify a set of users associated with the portion of the communications; and
insure the set of users for the category of activity based on the at least one insurance product.

10. The system of claim 9, wherein the instructions to access the communications from the at least one social media platform are further operable to perform at least one of crawling data from the social media platform to obtain the communications or sending an Application Program Interface (API) message to obtain the communications.

11. The system of claim 9, wherein the instructions to identify the set of users are further operable to:
identify each user associated with the portion of the communications;
determine a metric of interest in the category of activity for each user based on an interaction frequency between each user and the portion of the communications; and
select one or more users to form the set of users based on the metric of interest in the category of activity for each user.

12. The system of claim 9, wherein the instructions are further operable to generate one or more advertisements via the social media platform to provide information associated with the at least one insurance product to the set of users.

13. The system of claim 9, wherein the instructions are further operable to:
determine, for at least one user of the set of users and based on characteristics of communications generated by the at least one user, an individual risk score; and
identifying other insurance products available to the at least one user based on the individual risk score.

14. The system of claim 9, wherein the instructions are further operable to:
identify, based on the portion of the communications, a location that offers the activity; and
target the location with one or more advertisements, the one or more advertisements including information regarding the at least one insurance product.

15. The system of claim 9, wherein the set of users form an affinity group associated with the category of activity.

16. A tangible, non-transitory, computer-readable medium having instructions stored thereon, the instructions, when executed by a processor, are operable to:
access communications from at least one social media platform, the communications including at least one of text data or image data;
determine a portion of the communications corresponds to a category of activity;
determine a level of risk for the category of activity based on a potential for injury;
identify at least one insurance product based on the level of risk for the category of activity;
identify a set of users associated with the portion of the communications; and
insure the set of users for the category of activity based on the at least one insurance product.

17. The tangible, non-transitory, computer-readable medium of claim 16, wherein the instructions to identify the set of users are further operable to:
identify each user associated with the portion of the communications;
determine a metric of interest in the category of activity for each user based on an interaction frequency between each user and the portion of the communications; and
select one or more users to form the set of users based on the metric of interest in the category of activity for each user.

18. The tangible, non-transitory, computer-readable medium of claim 16, wherein the instructions to identify the set of users are further operable to:
determine, for at least one user of the set of users and based on characteristics of communications generated by the at least one user, an individual risk score; and
identifying other insurance products available to the at least one user based on the individual risk score.

19. The tangible, non-transitory, computer-readable medium of claim 16, wherein the instructions to identify the set of users are further operable to:
identify, based on the portion of the communications, a location that offers the activity; and
target the location with one or more advertisements, the one or more advertisements including information regarding the at least one insurance product.

20. The tangible, non-transitory, computer-readable medium of claim 16, wherein the instructions to access the communications from the at least one social media platform are further operable to perform at least one of crawling data from the social media platform to obtain the communications or sending an Application Program Interface (API) message to obtain the communications.
